(19) United States
(12) Patent Application Publication
(10) Pub. No.: US 2017/0096844 A1
(43) Pub. Date: Apr. 6, 2017

(54) EMERGENCY OPENING SYSTEM FOR VEHICLE LOCKS

(71) Applicant: EGG INNOVATION S.R.L.S., Vercelli (IT)

(72) Inventors: Edoardo Balocco, Vercelli (IT); Giancarlo Buso, Vercelli (IT); Gian Paolo Colombano, Vercelli (IT)

(73) Assignee: EGG INNOVATION S.r.l.s., Vercelli (IT)

(21) Appl. No.: 15/127,781

(22) PCT Filed: Mar. 20, 2015
(86) PCT No.: PCT/IB2015/052047

§ 371 Date: Sep. 20, 2016

(30) Foreign Application Priority Data
Mar. 20, 2014 (IT) VC2014A000001

(51) Int. Cl. E05B 77/30; E05B 79/12; E05B 77/10; E05B 85/04; E05B 15/02

(52) U.S. Cl. CPC E05B 77/30; E05B 85/04; E05B 15/022; E05B 77/10; E05B 79/12

(57) ABSTRACT

A device for emergency opening of a door lock of a motor vehicle comprises: a fixed plate (10); a movable plate (12) which is slidably mounted on the fixed plate (10), supports an engaging hook element (23) of the lock and has an extension (32) with a recess (34); a spring latch (18) which can be selectively extracted from the recess (34) so as to allow sliding of the movable plate (12); and operating means for performing extraction of the latch (18), such as a flat bar (16) which has one end connected to the latch (18) and an opposite end provided with an operating handle (14).

The present invention relates to the technical sector of mechanical engineering and in particular to opening systems or devices for emergency opening of a lock from inside substantially any vehicle.

According to the prior art, the known solutions relate to a system with explosive charges which are applied to the doors of vehicles and which, in the event of an emergency, are activated so as to blow off the lock from its seat, thus opening the door. Owing to the use of explosive materials, however, this system is inherently dangerous for the vehicle passengers.

The object of the present invention is to provide an emergency opening device for locks which is not subject to the drawbacks associated with the prior art.

The device according to the invention consists of a mechanical system which has the function of opening, in the event of an emergency, the doors and/or closing systems of vehicles, after being associated to the door locking system, so as to offer a way of escaping from inside the vehicle, without creating danger or harm for the occupants of the vehicle. Such a device is described in claim 1 below. Preferred characteristic features of the device according to the invention are described in the dependent claims.

The present invention relates furthermore to a vehicle comprising a device of the aforementioned type for the emergency opening of at least one lock.

Further characteristic features and advantages of the present invention will become clear from the following detailed description provided purely by way of a non-limiting example, with reference to the accompanying drawings in which:

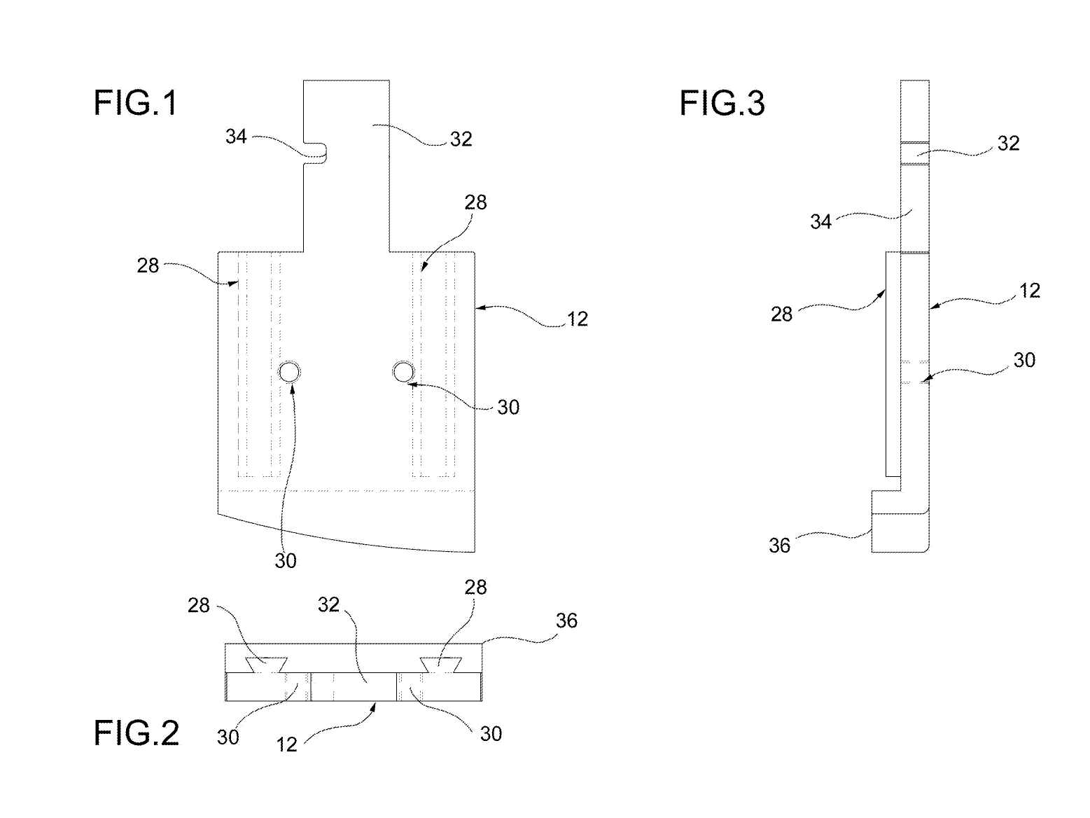

FIG. 1 is a plan view of a top plate of a device according to the invention;

FIG. 2 is a front-end view of the plate according to FIG. 1;

FIG. 3 is a side elevation view of the plate according to FIG. 1;

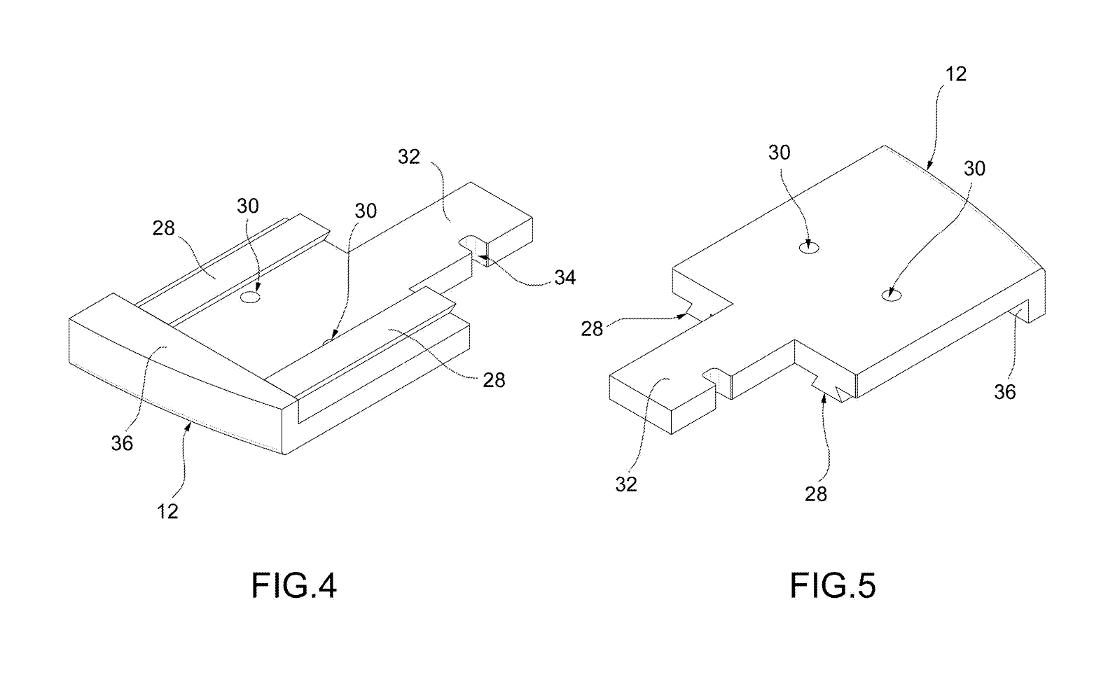

FIG. 4 is a perspective view of the plate according to FIG. 1;

FIG. 5 is a perspective view from a different angle of the plate according to FIG. 1;

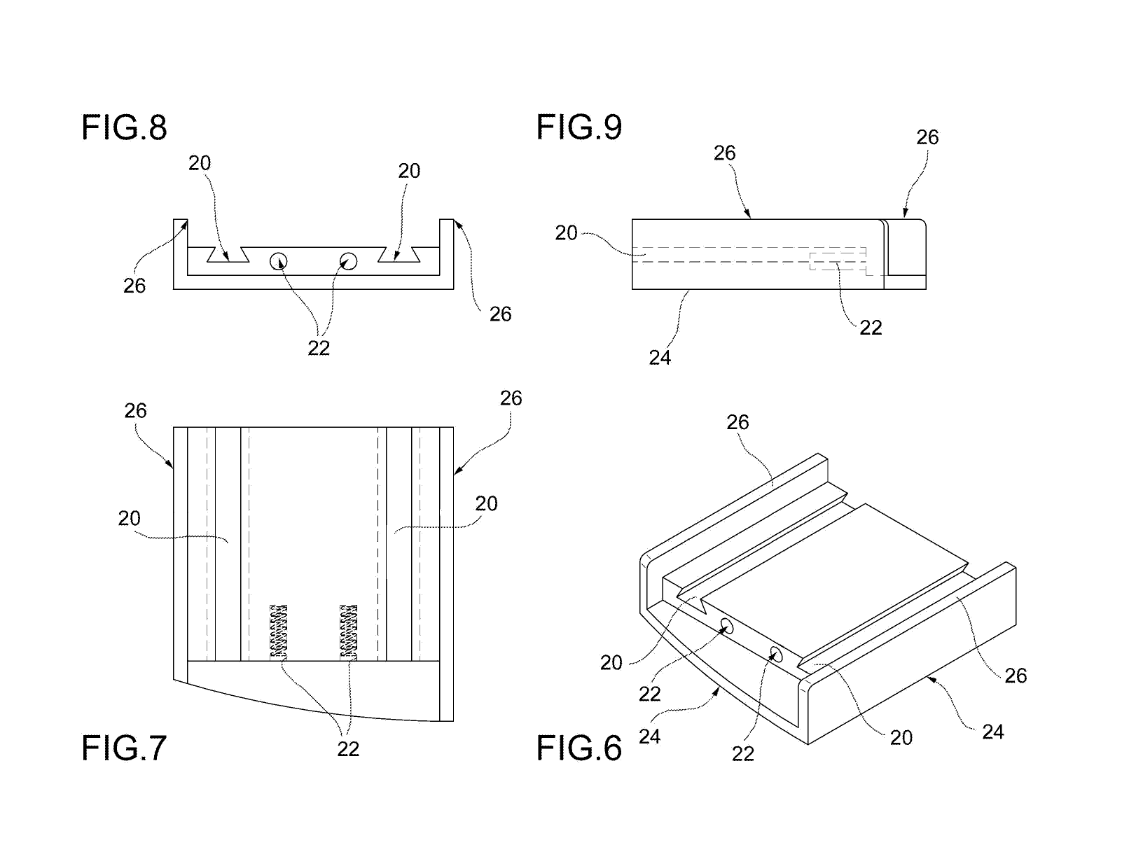

FIG. 6 is a perspective view of a bottom plate of the device according to the invention;

FIG. 7 is a top plan view of the plate according to FIG. 6;

FIG. 8 is a front view of the plate according to FIG. 6;

FIG. 9 is a side elevation view of the plate according to FIG. 6;

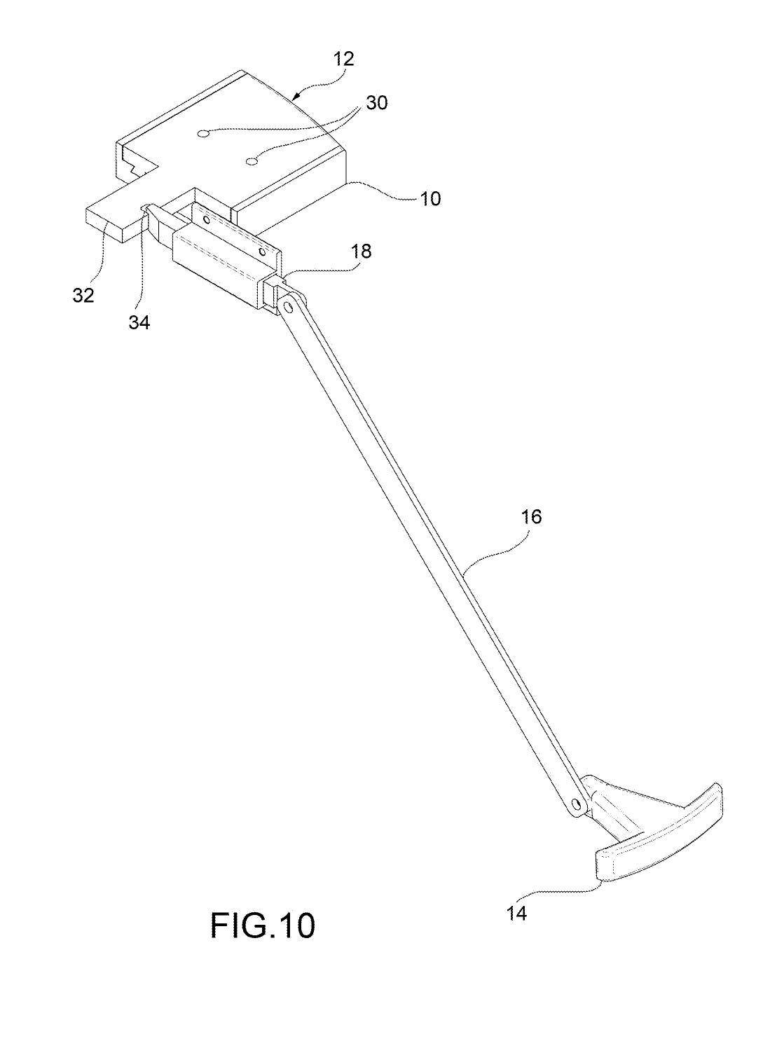

FIG. 10 is an overall perspective view of the device according to the invention; and

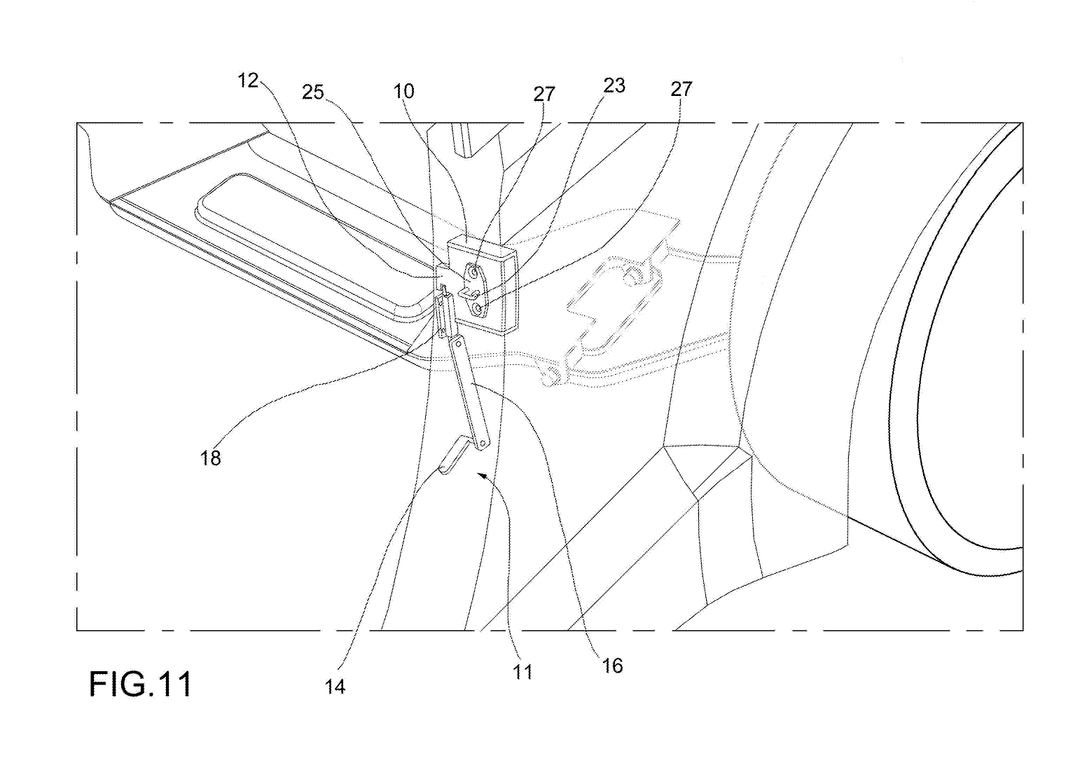

FIG. 11 is a schematic perspective view which illustrates installation of a device according to the invention on a motor-vehicle.

An emergency opening device for a per se conventional door lock of a vehicle comprises two plates or parts made of metal and/or other materials (cf. FIG. 10), a bottom one 10 of which being fixed to an upright or column 11 of the vehicle (cf. FIG. 11), and the other top movable one 12 of which sliding on the first plate 10. The device is operated, in the event of an emergency, directly by the occupants of the vehicle by means of a handle or knob 14 connected to a flat steel bar 16 which is in turn connected to a latch 18 advantageously of the spring type, which unlocks the movable plate 12 from the fixed plate 10, releasing the door from the locking unit, as will be explained in detail below.

The bottom plate 10 (cf. FIGS. 6-9) has negatively machined grooves 20 of the “dovetail” type as well as two holes 22 which extend substantially parallel to the general plane of the plate 10 and which serve as seats for respective elastic members (for example conventional helical springs, shown for simplicity only in FIG. 7) which assist expulsion and release from/engagement with a hook element 23 or “nose-piece” (shown for simplicity only in FIG. 11) designed to engage selectively with a movable member of the lock.

The hook element 23 protrudes from a plate 25 which has a pair of holes 27 aligned with respective threaded holes 30 formed in the plate 12 perpendicularly with respect to its general plane. The hook element 23 is fastened to the plate 12 by means of screws (not shown in the Figures) which engage inside the holes 30.

The surround or base 24 of the plate 10 bounds the device at the bottom and the thickness of side edges 26 projecting transversely from the plate 10 facilitates the operation of fixing, for example by means of welding, the plate 10 inside the seat which will be formed exactly in the centre of the closing nose-piece of the pre-existing conventional lock.

The top or movable plate 12 (cf. FIGS. 1-5) also has elements which are machined as dovetails, but positively, and which therefore are in the form of projections 28 substantially parallel to the general plane of said plate; by means of the engagement of the projections 28 inside the grooves 20 it is possible to achieve perfect mating of the two plates 10, 12, thus allowing full sliding of the plate 12 along the direction defined by the projections 28, which releases the hook element or nose-piece 23 from the movable member of the lock without requiring conventional operation of the latter. According to the present invention, the hook element 23 is no longer fixed to the fixed part of the frame of the vehicle which surrounds the opening closed by the door, but, as indicated above, is fixed to the movable or top plate 12 by means of the threaded holes 30. The top plate 12 also has an extension 32 with a rectangular recess 34 which acts as a fastening or engaging point for the spring latch (cf. FIG. 10) connected to the steel bar 16 which has, attached to its end, the handle or knob 14 which facilitates operation thereof in the event of an emergency. Pulling the handle or knob 14 actuates the spring latch 18 which is extracted from the rectangular recess 34, freeing the top plate 12. The latter is slid on the fixed plate 10 in only one direction determined by the action of the springs which are housed inside the holes 22 of the fixed plate 10 and which push against a projection 36 which protrudes from one end of the plate 12 opposite to that from which the extension 32 extends. In this way, the hook element or nose-piece 23 which is fixed to the plate 12 is released from engagement with the movable member of the lock mounted on the door, with the result that the latter is opened from inside the vehicle.

Of course, without altering the principle of the invention, the embodiments and the constructional details may be greatly varied with respect to that described and illustrated purely by way of a non-limiting example, without thereby departing from the scope of the invention as defined in the accompanying claims. For example, the positioning of the grooves 20 and the projections 28 on the fixed plate 10 and movable plate 12, respectively, could be reversed, and the grooves 20 and projections 28 could be present in any number. Furthermore, the means for operating the device, and in particular the means for performing extraction of the latch 18, such as the flat bar 16 and the handle or knob 14, may be designed with different forms, as illustrated by way of example in FIGS. 10 and 11, respectively. Moreover, the materials used for the manufacture of the various components of the device according to the invention may be substantially of any nature, in particular ferrous or non-ferrous materials, and the device may have dimensions most suitable for adaptation to the dimensions of the opening closed by the door or hatch on which the lock is mounted.

1. A device for emergency opening of a lock from inside a motor vehicle, comprising:
a fixed plate
a movable plate which is slidably mounted on said fixed plate, supports an engaging hook element of said lock and has an extension with a recess;
a spring latch which can be selectively extracted from said recess so as to allow the sliding of said movable plate; and
operating means for performing extraction of said latch, such as a flat bar which has one end connected to said latch and an opposite end provided with an operating handle.

2. The device of claim 1, wherein said fixed plate has at least one dovetail groove and said movable plate has at least one dovetail projection which has a cross-section respectively corresponding to that of the groove of the fixed plate so as to allow the sliding engagement of said plates.

3. The device according of claim 1, wherein said recess has a substantially rectangular shape.

4. The device of claim 1, wherein said fixed plate has at least two holes which are directed parallel to the direction of sliding of the movable plate and act as seats for respective elastic members which push against a projection which protrudes from one end of the movable plate opposite to an end from which said extension protrudes.

5. The device according to claim 1, wherein said movable plate has holes, in particular threaded holes for allowing fixing of said hook element.

6. A vehicle comprising an emergency opening device for at least one lock according to claim 1.

7. The vehicle of claim 6, wherein said fixed plate is fixed to an upright which bounds an opening closed by a door on which said lock is mounted.
